(19) United States
(12) Patent Application Publication
(10) Pub. No.: US 2005/0169006 A1
(43) Pub. Date: Aug. 4, 2005

(54) Led chip lamp apparatus

(75) Inventors: Bily Wang, Hsin Chu City (TW); Jonnie Chuang, Pan Chiao City (TW); Ching Hung Ko, Tai Nan City (TW)

Correspondence Address: TROXELL LAW OFFICE PLLC;SUITE 1404, 5205 LEESBURG PIKE, FALLS CHURCH, VA, 22041, US

(73) Assignee: HARVATEK CORPORATION

(21) Appl. No.: 10/766,827

(22) Filed: Jan. 30, 2004

(51) Int. Cl. F21V 7/04

(52) U.S. Cl. 362/555

(57) ABSTRACT

An LED chap lamp apparatus has a heat sink with a reflector, an LED lamp module and a heat pipe. The LED lamp module is assembled on an inside of the reflector for reflecting light of the LED lamp module. The two ends of the heat pipe each connect to the LED lamp module and the heat sink to conduct and disperse the heat produced form the LED chips to increase the lifetime and the light-emitting efficiency of the LED chap lamp apparatus.

### BACKGROUND OF THE INVENTION

1. Field of the Invention

The present invention relates to an LED chip lamp apparatus for transmitting and dispersing heat generated from the LED chips.

2. Description of the Related Art

Reference is made to FIG. 1. A conventional LED chip lamp apparatus includes a retaining body 10a, a coupling member 20a, a reflector housing 30a, an electrical conduction barrel 40a, a transparent cover 50a and a plurality of LED chips 60a. The retaining body 10a has a concavity portion 11a with the reflector housing 30a positioned therein. Both the retaining body 20a and the reflector housing 30a respectively have a first through hole 12a, and the two first through holes 12a are communicated to each other. The coupling member 20a has two ends; each extends through the first through hole 12a of the retaining body 20a and the reflector housing 30a to engage the first through hole 12a edge on the retaining body 20a and the reflector housing 30a. The coupling member 20a has a second through hole 21a for inserting an end of the electric conduction barrel therein, and another end of the electric conduction barrel 40a has an out oblique ring face 41a received in the center of the inside of the reflector housing 30a. The LED chips is mounted on the outer oblique ring face 41a of the electric conduction barrel 40a to make electrical contact and emit light reflected in one direction by reflector housing 30a.

The conventional LED chip lamp apparatus still has defects, which are described as follows. An LED chip generates heat when it emits light. This is particularly true when an LED is used in an illumination apparatus, where the light emitted by the LED chip is double and both the required electric current and the resultant heat are doubled. However, the high heat of the LED chip lamp apparatus can't be effectively dispersed and the work effect of the LED chips thus declines. Furthermore, the LED chip lamp apparatus is used in a high heat state for a long time and the lifetime thereof is consequently shortened.

### SUMMARY OF THE INVENTION

It is therefore a principal object of the invention to provide an LED chip lamp apparatus with a heat sink added thereto for conducting and dispersing the heat of the LED chip.

It is therefore a secondary object of the invention to provide an LED chip lamp apparatus with increased lifetime and light-emitting efficiency.

To achieve the above objects, the present invention provides an LED chip lamp apparatus comprising a heat sink with a reflector, an LED lamp module and a heat pipe. The LED lamp module is assembled in an inside of the reflector for reflecting light of the LED lamp module. The heat pipe has two ends, one end thereof connecting to the LED lamp module and the other end thereof connecting to the heat sink for transmitting heat of the LED lamp module so as to conduct and disperse the heat produced from an LED chip and to increase the lifetime and the light emitting efficiency of the LED chip lamp apparatus.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a cross-sectional view of an LED chip lamp apparatus of a prior art;

FIG. 2 is a cross-sectional view of an LED chip lamp apparatus of the present invention;

FIG. 3 is an enlarged view of a circuit substrate shaped as an unfolded frustum of a quadrangular pyramid according to the present invention;

FIG. 4 is an enlarged view of a circuit substrate shaped as an unfolded frustum of a quadrangular pyramid according to the present invention; and

FIG. 5 is an enlarged view of a circuit substrate shaped as an unfolded frustum of a hexagonal pyramid according to the present invention.

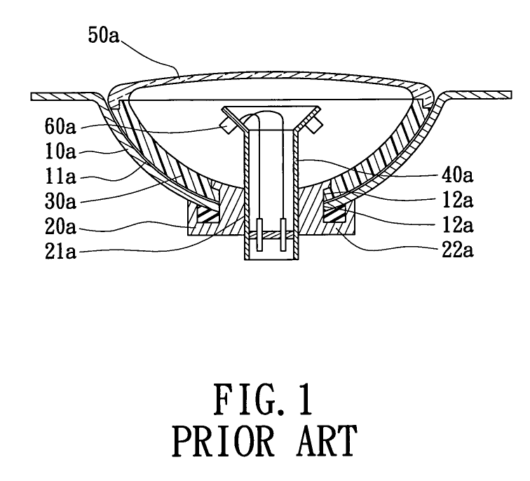

### DETAILED DESCRIPTION OF THE EMBODIMENTS

Wherever possible in the following description, like reference numerals will refer to like elements and parts unless otherwise illustrated.

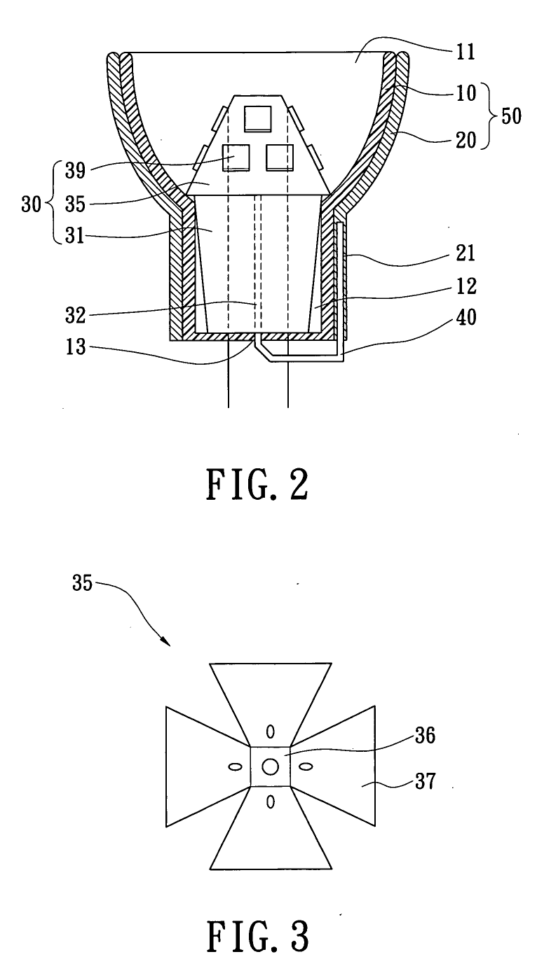

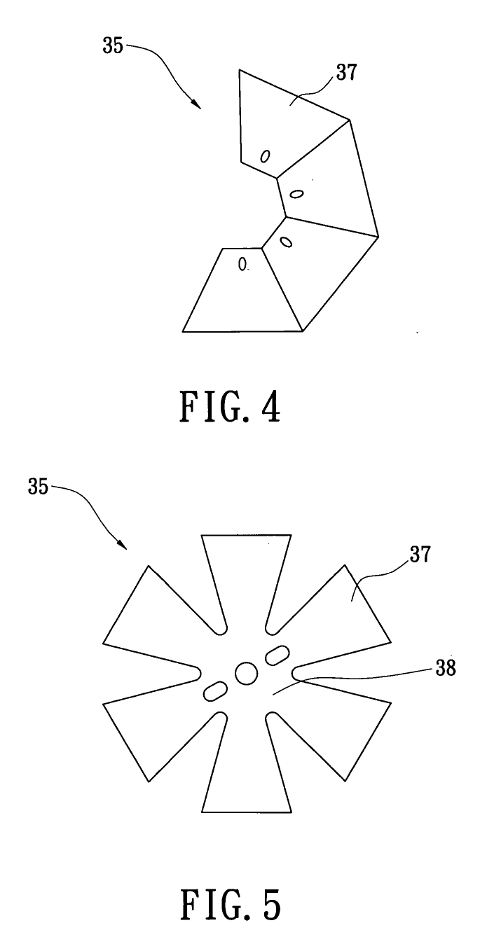

Referring now to FIGS. 2 to 5, the present invention provides an LED chip lamp apparatus comprising a heat sink with reflector 50, an LED lamp module 30 and a heat pipe 40. The LED lamp module 30 is assembled inside the reflector. An end of the heat pipe 40 connects to the LED lamp module 30 and the other end of the heat pipe 40 connects to the heat sink 50 so that the LED lamp module 30 generates heat transmitted to the heat sink 50 by the heat pipe 40 to disperse heat to increase the lifetime and the light emitting efficiency.

Referring now to FIG. 2, the heat sink with reflector 50 comprises a heat conductor 20 and a reflector housing 10. The heat conductor 20 surrounds the reflector housing 10, and the one end of the heat pipe 20 connects to the heat conductor 20. The reflector housing 10 has two ends. One end forms an open end 11 and has a half ellipsoid shape therein. The other end shrinkingly forms a receiving portion 12 at an inside thereof, and the LED lamp module 30 is positioned in a center portion of the inside of the open end 11 and is extendedly retained in the receiving portion 12. The end of the reflector housing 10 has a through hole 13 communicating with the receiving portion 12. One end of the heat pipe 40 extends through the through hole 13 to connect the LED lamp module 30, and the other end of the heat pipe 40 connects to the heat conductor 20. A sidewall of the heat conductor 20 is the same as the reflector housing 10, surrounds the reflector housing 10 and has a concavity portion 21 at a downside thereof for receiving one end of the heat pipe 40.

Referring now to FIG. 2, the LED lamp module 30 comprises a heat conduction carrier 31, a circuit substrate 35, and a plurality of LED chips 39. The heat conduction carrier 31 has a front end and a rear end. The rear end is assembled inside the reflector housing 10, retains the receiving portion 12 and has a cavity 32. One end of the heat pipe 40 extends into the cavity 32 and is retained in the cavity 32. Further, the LED chip 39 is mounted and electrically connected on the circuit substrate 35. The front end of the heat conduction carrier 31 is formed as a frustum of a pyramid and received inside the center of the reflector housing 10. Referring to FIGS. 2 to 5, the circuit substrate 35 is formed as an unfolded frustum of a pyramid. When the end of the heat conduction carrier 31 is formed as a frustum of a quadrangular pyramid, the circuit substrate 35 forms a rectangular board 36 and four trapezoidal boards 37 respectively connecting to four sides of the rectangular board 36, or forms four trapezoidal boards 37 connected in a row. When the end of the heat conduction carrier 31 is formed as a frustum of a hexagonal pyramid, the circuit substrate 35 forms a hexagonal board 38 and six trapezoidal boards 37 respectively connecting to six sides of the hexagonal board 38. Therefore, the circuit substrate 35 covers the front end of the heat conduction carrier 31 to mount the LED chips 39 thereon.

Therefore, the heat conduction carrier 31 carries the circuit substrate 35 and the LED chips 39 to collect and transmit the heat generated from the LED chips 39 and then via the heat pipe 40 connecting to the heat conductor 20 to reduce the cumulative heat to increase the lifetime and the light emitting efficiency of the LED chip lamp apparatus.

To sum up, the present invention provides an LED chip lamp apparatus to add a heat sink for transmitting and dispersing heat of the LED chip and to increase the lifetime and the light emitting efficiency thereof.

There has thus been described a new, novel and heretofore unobvious printed circuit board which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

1. An LED chip lamp apparatus, comprising:
a heat sink with a reflector;
an LED lamp module assembled in an inside of the reflector for reflecting light of the LED lamp module; and
a heat pipe having two ends, one end thereof connecting to the LED lamp module and the other end thereof connecting to the heat sink for transmitting heat of the LED lamp module.

2. The LED chip lamp apparatus of the claim 1, wherein the heat sink has a semi-elliptic shaped open end formed inside of one end of two ends thereof and a receiving portion shrinkingly formed inside of another end of the two ends thereof, and wherein the LED lamp module is positioned in a center portion inside the open end and extendedly retained in the receiving portion.

3. The LED chip lamp apparatus of the claim 2, wherein the heat sink has a through hole communicated with the receiving portion, one end of the heat pipe extending through the through hole to connect the LED lamp module, and another end of the heat pipe connecting to the heat sink.

4. The LED chip lamp apparatus of the claim 1, wherein the heat sink comprises a reflector housing and a heat conductor, the heat conductor surrounding an outside of the reflector housing, and one end of the heat pipe connecting to the heat conductor.

5. The LED chip lamp apparatus of the claim 4, wherein the heat conductor has a concavity in a sidewall thereof for receiving the one end of the heat pipe.

6. The LED chip lamp apparatus of the claim 4, wherein the LED lamp module comprises a heat conduction carrier having a front end and a rear end, the rear end assembled in an inside of the reflector and connected to one end of the heat pipe, a circuit substrate positioned in the front end of the heat conduction carrier, and a plurality of the LED chips in electrical contact on the circuit substrate.

7. The LED chip lamp apparatus of the claim 6, wherein the front end of the heat conduction carrier is a frustum of a pyramid.

8. The LED chip lamp apparatus of the claim 7, wherein the circuit substrate is formed as an unfolded frustum of a pyramid.

9. The LED chip lamp apparatus of the claim 7, wherein the circuit substrate comprises a hexagonal board and six trapezoidal boards respectively connected to six sides of the hexagonal board and covers the front end of the heat conduction carrier.

10. The LED chip lamp apparatus of the claim 7, wherein the circuit substrate comprises a rectangular board and four trapezoidal boards respectively connected to four sides of the rectangular board and covers the front end of the heat conduction carrier.

11. The LED chip lamp apparatus of the claim 7, wherein the circuit substrate comprises a plurality of the trapezoids boards connected in a series and covers the front end of the heat conduction carrier.

12. The LED chip lamp apparatus of the claim 6, wherein the heat conduction carrier has a cavity, one end of the heat pipe being retained in the cavity.

13. AN LED chip lamp apparatus, comprising:
a reflector housing having two ends, one end of the reflector housing being formed as an open end having a semi-ellipsoid shape, and another end having a receiving portion shrinkingly formed inside;
a heat conductor positioned outside and surrounding the reflector housing;
a heat conduction carrier having a front end and a rear end, the rear end extending to the receiving portion and being retaining in the receiving portion, the front end positioned inside the open end;
a heat pipe having two ends, one end connecting to the heat conduction carrier, and another end being bent and extendedly connecting to the heat conductor;
a circuit substrate positioned on the front end of the heat conduction carrier; and
a plurality of LED chips mounted on the circuit substrate.

14. The LED chip lamp apparatus of the claim 13, wherein the circuit substrate is formed as an unfolded frustum of a pyramid.

15. The LED chip lamp apparatus of the claim 13, wherein the circuit substrate comprises a hexagonal board and six trapezoidal boards respectively connected to six sides of the hexagonal board and covers the front end of the heat conduction carrier.

16. The LED chip lamp apparatus of the claim 13, wherein the circuit substrate comprises a rectangular board and four trapezoidal boards respectively connected to four sides of the rectangular board and covers the front end of the heat conduction carrier.

17. The LED chip lamp apparatus of the claim 13, wherein the circuit substrate comprises a plurality of the trapezoidal boards connected in a series and covers the front end of the heat conduction carrier.

18. The LED chip lamp apparatus of the claim 13, wherein the heat conduction carrier has a cavity, and one end of the heat pipe is retained in the cavity.
